(19) United States
(12) Patent Application Publication
(10) Pub. No.: US 2026/0245775 A1
(43) Pub. Date: Aug. 20, 2026

(54) MAGNETIC POWDER AND COMPOSITE MAGNETIC MATERIAL

(71) Applicant: Panasonic Intellectual Property Management Co., Ltd., Osaka (JP)

(72) Inventors: Kanako SUGIMURA, Osaka (JP); Junichi KOTANI, Hyogo (JP)

(21) Appl. No.: 18/848,404

(22) PCT Filed: Mar. 15, 2023
(86) PCT No.: PCT/JP2023/009975

§ 371 Date: Sep. 18, 2024

(30) Foreign Application Priority Data
Mar. 30, 2022 (JP) 2022-056954

(51) Int. Cl. H01F 1/20

(52) U.S. Cl. CPC H01F 1/20

(57) ABSTRACT

Magnetic powder contains magnetic particles. The magnetic particles include: metal magnetic particles; a non-magnetic resin layer coating surfaces of metal magnetic particles, and an inorganic insulating layer coating the non-magnetic resin layer.

### TECHNICAL FIELD

The present disclosure relates to magnetic powder and a composite magnetic material containing the magnetic powder.

### BACKGROUND ART

Magnetic powder is typically used as a magnetic material for the magnetic cores of inductors and transformers. Examples of these magnetic cores made of such a magnetic material include composite magnetic material obtained by compression molding of the magnetic material. Composite magnetic material is magnetic cores with a high saturation flux density and the advantage of downsizing the components of an inductor and a transformer. In addition, a composite magnetic material can be molded with a mold and thus has flexibility in the formation of magnetic cores. Even in a complicated shape, composite magnetic material can be manufactured highly accurately by a simple process. The utility of composite magnetic material is thus drawing attention.

For example, Patent Literature (PTL) 1 discloses a composite magnetic material made of iron-based soft magnetic powder containing magnetic particles each of which has a surface coated with an inorganic insulating layer.

### CITATION LIST

### Patent Literature

[PTL 1] International Publication No. WO 2016/043295

### SUMMARY OF INVENTION

### Technical Problems

An increase in the withstand voltage of a composite magnetic material is required to downsize an inductor, a transformer, or other suitable components. An “increase in the withstand voltage” is increasing the maximum voltage applicable to a composite magnetic material without causing any dielectric breakdown. In order to increase the withstand voltage, improving the insulation between the magnetic particles of magnetic powder is important. For example, the insulation between the particles of magnetic powder can be improved by forming an insulating layer on the surfaces of the particles of the magnetic powder. As in PTL 1, however, an insulating layer made of an inorganic material may have a crack in compression in the molding of the composite magnetic material. Once a crack occurs, dielectric breakdown is likely to occur, which reduces the withstand voltage. With such an insulating layer containing an inorganic material, the withstand voltage may increase insufficiently.

In view of the problems, it is an objective of the present disclosure to increase the withstand voltage of a composite magnetic material.

### Solution to Problems

Magnetic powder according to an aspect of the present disclosure contains: magnetic particles. Each of the magnetic particles includes: a metal magnetic particle; a non-magnetic resin layer coating a surface of the metal magnetic particle; and an inorganic insulating layer coating the non-magnetic resin layer.

A composite magnetic material according to an aspect of the present disclosure includes: the magnetic powder described above; and a non-magnetic resin member that binds the magnetic particles of the magnetic powder.

### Advantageous Effects of Invention

The present disclosure increases the withstand voltage of a composite magnetic material.

### BRIEF DESCRIPTION OF DRAWINGS

FIG. 1 is a general perspective view showing a configuration of a coil component according to an embodiment.

FIG. 2 is a cross-sectional view showing the configuration of the coil component according to the embodiment.

FIG. 3 is a cross-sectional view showing an internal configuration of a composite magnetic material according to the embodiment.

FIG. 4 is a cross-sectional view showing a crack in magnetic particle according to the embodiment.

FIG. 5 is a cross-sectional view showing a crack in magnetic particle according to the embodiment.

FIG. 6 is a cross-sectional view showing a crack in magnetic particle according to the embodiment.

FIG. 7 is a flowchart showing a step of manufacturing the coil component according to the embodiment.

FIG. 8 is a flowchart showing a coating step according to the embodiment.

FIG. 9 is a flowchart showing a step of manufacturing granulated powder according to the embodiment.

FIG. 10 is a flowchart showing a step of manufacturing a core and assembling a coil according to the embodiment.

FIG. 11 shows an analysis model containing magnetic particles according to a comparative example.

FIG. 12 shows another analysis model containing the magnetic particles according to a comparative example.

FIG. 13 shows an analysis model containing magnetic particles according to the embodiment.

FIG. 14 shows another analysis model containing the magnetic particles according to the embodiment.

FIG. 15 shows further another analysis model containing the magnetic particles according to the embodiment.

FIG. 16 shows an example result of electric field analysis.

FIG. 17 shows another example result of electric field analysis.

### DESCRIPTION OF EMBODIMENT

Now, an embodiment will be described in detail with reference to the drawings.

The embodiment described below is merely a specific example of the present disclosure. The numerical values, shapes, materials, elements, the arrangement and connection of the elements, steps, step orders etc. shown in the following embodiment are thus merely examples, and are not intended to limit the scope of the present disclosure. Among the elements in the following embodiment, those not recited in the independent claims will be described as optional.

The figures are schematic representations and not necessarily drawn strictly to scale. The scales are thus not necessarily the same in the figures. The same reference signs represent substantially the same configurations in the drawings and redundant description will be omitted or simplified.

In this specification, the terms, such as “parallel” or “orthogonal” representing the relationships between elements, the terms, such as “rectangular” or “parallelepiped” representing the shapes of elements, and numerical ranges are expressions having not only the exact meaning but also covering substantially equivalent ranges, such as the differences of several percentages.

### Embodiment

Now, magnetic powder, a composite magnetic material containing the magnetic powder, and a coil component including the composite magnetic material according to the embodiment will be described.

### [1-1. Configuration of Coil Component]

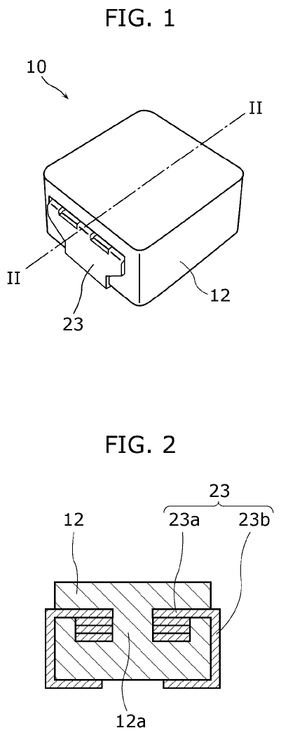

FIG. 1 is a general perspective view showing a configuration of coil component 10 according to this embodiment. FIG. 2 is a cross-sectional view showing the configuration of coil component 10 according to this embodiment. FIG. 2 shows the cross section taken along the line II-II in FIG. 1.

As shown in FIGS. 1 and 2, coil component 10 includes composite magnetic material 12 and coil member 23. Specifically, coil component 10 includes composite magnetic material 12, which is a magnetic core made of a magnetic material containing magnetic powder, and coil member 23 inside composite magnetic material 12. Coil component 10 is an inductor, for example.

Composite magnetic material 12 includes columnar core 12a near the center in plan view. Coil member 23 is located around columnar core 12a of composite magnetic material 12.

Coil member 23 includes wound part 23a wounded with a conductor a plurality of times, and wiring 23b outside composite magnetic material 12. As a winding axis of the conductor wound around wound part 23a, core 12a of composite magnetic material 12 is provided. The conductor is copper, for example. The conductor is made of a material not broken by heat applied when forming coil component 10.

Wound part 23a of coil member 23 is buried inside composite magnetic material 12, while wiring 23b is located outside composite magnetic material 12. Coil member 23 is integral with composite magnetic material 12, for example. Coil member 23 may be a different body from composite magnetic material 12, and composite magnetic material 12 and coil member 23 may be assembled.

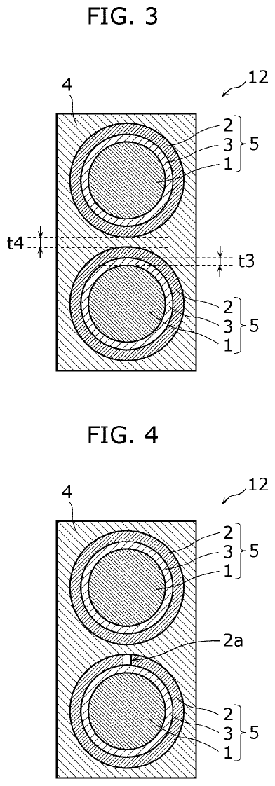

Now, an internal configuration of composite magnetic material 12 will be described. FIG. 3 is a cross-sectional view showing the internal configuration of composite magnetic material 12. FIG. 3 schematically shows an area including two magnetic particles 5 in an internal cross section of composite magnetic material 12.

As shown in FIG. 3, composite magnetic material 12 includes magnetic powder containing magnetic particles 5, and non-magnetic resin members 4 each of which binds magnetic particles 5 of the magnetic powder. In addition, composite magnetic material 12 may further include a coupling agent for improving the dispersion of the magnetic powder and the surface modification of the magnetic powder, and an organic metal soap as a lubricant. Examples of the coupling agent include a silane coupling agent, a titanium-based coupling agent, titanium alkoxide, and titanium chelate. Examples of the metal soap include zinc stearate, calcium stearate, magnesium stearate, and barium stearate.

Each non-magnetic resin member 4 binds magnetic particles 5 of the magnetic powder. Non-magnetic resin member 4 keeps the shape of composite magnetic material 12. Non-magnetic resin member 4 is made of an insulating resin material. The resin material making non-magnetic resin member 4 is a thermosetting resin, for example. The resin material making non-magnetic resin member 4 may be a thermoplastic resin. Examples of the thermosetting resin include an epoxy resin, a phenol resin, a silicone resin, and polyimide. Examples of the thermoplastic resin include an acrylic resin, polyethylene, polypropylene, and polystyrene.

Non-magnetic resin member 4 has a relative permittivity ranging from 1.5 to 10, for example.

Non-magnetic resin member 4 has a weight ranging from 1% to 10%, for example, with respect to the weight of the magnetic powder.

The magnetic powder contains a large number of magnetic particles 5 and is dispersed in composite magnetic material 12. The surface of each magnetic particle 5 is covered with non-magnetic resin member 4. Non-magnetic resin members 4 covering the surfaces of adjacent ones of magnetic particles 5 bind to each other. That is, each non-magnetic resin member 4 is interposed between magnetic particles 5 to insulate magnetic particles 5 from each other.

Magnetic particles 5 making the magnetic powder have median diameter D50 ranging from 5 μm to 35 μm, for example. Small median diameter D50 of the magnetic powder for reducing the concentration of the electric field between the particles ensures insulating properties. Median diameter D50 within the range described above ensures a high filling rate and handling properties. Median diameter D50 of 35 μm or less of the magnetic powder reduces the core loss, particularly, the eddy current loss within a high-frequency range. Note that median diameter D50 of the magnetic powder is the particle diameter when the volume-based particle size distribution meter measured by laser diffraction scattering method counts from the smallest particle size and the integrated value is 50% of the total.

Each magnetic particle 5 includes metal magnetic particle 1, non-magnetic resin layer 3 coating the surface of metal magnetic particle 1, and inorganic insulating layer 2 coating non-magnetic resin layer 3. Magnetic particle 5 includes metal magnetic particle 1, non-magnetic resin layer 3, and inorganic insulating layer 2 in this order from the center to the outside. Inorganic insulating layer 2 is on the outermost surface of magnetic particle 5.

Metal magnetic particle 1 is a metal soft magnetic particle containing iron, for example. Examples of the material of metal magnetic particle 1 include pure iron, an Fe—Si—Al-based alloy, an Fe—Si-based alloy, an Fe—Si—Cr-based alloy, an Fe—Ni-based alloy, an Fe—Co-based alloy, an amorphous alloy, and a nanocrystalline alloy.

The method of producing metal magnetic particle 1 according to this embodiment is not particularly limited. Various atomizing methods, various chemical methods, or various grinding methods can be employed.

For example, non-magnetic resin layer 3 covers the entire surface of metal magnetic particle 1 and is in contact with metal magnetic particle 1. Non-magnetic resin layer 3 is interposed between metal magnetic particle 1 and inorganic insulating layer 2. Non-magnetic resin layer 3 has a thickness ranging from 1 nm to 30 nm, for example.

Non-magnetic resin layer 3 is made of an insulating resin material. The resin material making non-magnetic resin layer 3 is a thermosetting resin or a thermoplastic resin, for example. Examples of the thermosetting resin include an epoxy resin, a phenol resin, a silicone resin, and polyimide. Examples of the thermoplastic resin include an acrylic resin, polyethylene, polypropylene, and polystyrene.

Non-magnetic resin layer 3 has a relative dielectric constant ranging from 1.5 to 10, for example.

For example, inorganic insulating layer 2 covers the entire outer surface of non-magnetic resin layer 3 and is in contact with non-magnetic resin layer 3. Inorganic insulating layer 2 is interposed between non-magnetic resin layer 3 and non-magnetic resin member 4. The outer surface of inorganic insulating layer 2 is in contact with non-magnetic resin member 4. Inorganic insulating layer 2 has a thickness ranging from 1 nm to 30 nm, for example.

Inorganic insulating layer 2 is made of an inorganic insulating material. Examples of the resin material making inorganic insulating layer 2 include metal oxides, such as silicon oxide.

Inorganic insulating layer 2 has a relative dielectric constant ranging from 3 to 12, for example.

Here, the relationships between the thicknesses and the relative permittivity of non-magnetic resin layer 3 and non-magnetic resin member 4 will be described. In the following, ε3 is the relative permittivity of non-magnetic resin layer 3, while ε4 is the relative permittivity of non-magnetic resin member 4. As shown in FIG. 3, t3 is the thickness of non-magnetic resin layer 3, while t4 is the thickness of the thinnest part of non-magnetic resin member 4 between adjacent ones of magnetic particles 5. It can be said that t4 corresponds to the shortest distance between adjacent ones of magnetic particles 5. If there is a distribution within composite magnetic material 12 for t3 and t4, t3 and t4 each represent the average of the thicknesses at a plurality of points measured using a cross-sectional photograph with a predetermined area.

For example, the relationship between the thicknesses of non-magnetic resin layer 3 and non-magnetic resin member 4 satisfies the expression t3≥0.76×t4.

For example, the relationship between the thicknesses and the relative permittivity of non-magnetic resin layer 3 and non-magnetic resin member 4 satisfies the expressions t3≥0.45×t4 and ε3≥ε4, respectively.

For example, the relationship between the relative permittivity of non-magnetic resin layer 3 and non-magnetic resin member 4 satisfies the expression ε3≥ε4.

Once a voltage is applied to composite magnetic material 12 satisfying any of the relationships described above, the maximum electric field on composite magnetic material 12 can be reduced. The withstand voltage of composite magnetic material 12 can increase. The detail of this advantage will be described later.

### [1-2. Form of Magnetic Particles Existing in Composite Magnetic Material]

Next, the form of magnetic particles 5 existing in the composite magnetic material will be described. Inorganic insulating layer 2 of magnetic particles 5 is made of an inorganic material which is more likely to crack than resin materials. By compression and any other suitable process when forming composite magnetic material 12, inorganic insulating layer 2 may have a crack. FIGS. 4 to 6 are each a cross-sectional view showing a crack in magnetic particle 5 according to this embodiment.

As shown in FIG. 4, for example, inorganic insulating layer 2 of magnetic particles 5 may have crack 2a. Crack 2a shown in FIG. 4 is a void filled with air, for example. Once crack 2a occurs and metal magnetic particles 1 come into contact with each other via crack 2a, the withstand voltage of composite magnetic material 12 decreases. In this embodiment, non-magnetic resin layer 3 exists between each metal magnetic particle 1 and corresponding inorganic insulating layer 2. This configuration reduces the contact between metal magnetic particles 1 even at the occurrence of crack 2a in inorganic insulating layer 2 and increases the withstand voltage of composite magnetic material 12. The electric field tends to be concentrated at crack 2a, which is the void, when a voltage is applied to composite magnetic material 12. Since non-magnetic resin layer 3 exists between metal magnetic particle 1 and inorganic insulating layer 2, however, the electric field is less concentrated at crack 2a.

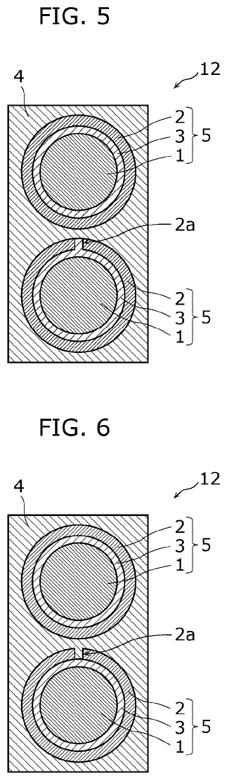

In this embodiment, each magnetic particle 5 include non-magnetic resin layer 3 inside inorganic insulating layer 2. As shown in FIG. 5, crack 2a may be filled with the resin material making non-magnetic resin layer 3. This configuration further reduces the concentration of the electric field at crack 2a. As shown in FIG. 6, crack 2a may be filled with the resin material making non-magnetic resin member 4. Crack 2a may be filled with both the resin material making non-magnetic resin layer 3 and the resin material making non-magnetic resin member 4. A part of crack 2a filled with a resin material may have a void.

Whether there is crack 2a and which of the states in FIGS. 4 to 6 is crack 2a depends on the characteristics of the material of composite magnetic material 12 and the molding pressure in the compression when forming composite magnetic material 12. Thus, the magnetic powder of composite magnetic material 12 may contain only magnetic particles 5 without any crack 2a as shown in FIG. 3, or contain at least any of magnetic particles 5 with cracks 2a shown in FIGS. 4 to 6. If the magnetic powder of composite magnetic material 12 contains at least any of magnetic particles 5 with cracks 2a shown in FIGS. 4 to 6, the magnetic powder may be a mixture of magnetic particles 5 without any crack 2a as shown in FIG. 3 and one or more of magnetic particles 5 with cracks 2a shown in FIGS. 4 to 6. The magnetic powder may contain only one or more of magnetic particles 5 with cracks 2a shown in FIGS. 4 to 6. One magnetic particle 5 may have a plurality of cracks 2a.

As described above, the magnetic powder according to this embodiment contains magnetic particles 5. Each magnetic particle 5 includes metal magnetic particle 1; non-magnetic resin layer 3 coating the surface of metal magnetic particle 1, and inorganic insulating layer 2 coating non-magnetic resin layer 3. On the other hand, composite magnetic material 12 according to this embodiment includes magnetic powder and non-magnetic resin member 4 that binds the magnetic powder and magnetic particles 5 of the magnetic powder.

With this configuration, inorganic insulating layer 2 and non-magnetic resin layer 3 improve the insulation between magnetic particles 5. Assume that inorganic insulating layer 2 has crack 2a due to the molding pressure when forming composite magnetic material 12. Even in this case, inorganic insulating layer 2 coating non-magnetic resin layer 3 reduces a deterioration in the insulation between magnetic particles 5 due to the contact between metal magnetic particles 1. Accordingly, the withstand voltage of composite magnetic material 12 increases.

### [1-3. Method of Manufacturing Magnetic Powder, Magnetic Material, and Coil Component]

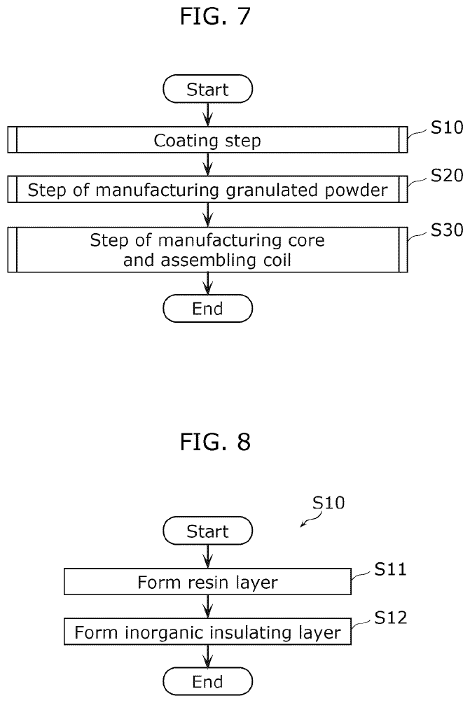

Now, a method of manufacturing the magnetic powder, the magnetic material, and the coil component according to this embodiment will be described. FIG. 7 is a flowchart showing a step of manufacturing coil component 10 according to this embodiment.

As shown in FIG. 7, the step of manufacturing coil component 10 according to this embodiment includes, for example, a coating step (step S10), a step of manufacturing granulated powder (step S20), and a step of manufacturing a core and assembling a coil (step S30). The coating step is for generating magnetic powder containing magnetic particles 5. The step of manufacturing granulated powder is for generating the magnetic material making composite magnetic material 12. The step of manufacturing a core is for forming coil member 23 and composite magnetic material 12, which is obtained by molding the magnetic material, and assembling composite magnetic material 12 and coil member 23 to complete coil component 10. In the following, the case where a thermosetting resin is used as the material of non-magnetic resin member 4 will be described.

FIG. 8 is a flowchart showing the coating step according to this embodiment. As shown in FIG. 8, in the coating step, first, non-magnetic resin layer 3 is formed on the surface of metal magnetic particle 1 (step S11). Specifically, for example, the metal powder containing metal magnetic particle 1, the resin material which is the material of non-magnetic resin layer 3, and an organic solvent are mixed to form a resin solution coating the surface of metal magnetic particle 1. After that, the organic solvent is removed by heat treatment to form non-magnetic resin layer 3 coating the surface of metal magnetic particle 1. A higher mixing ratio of the resin material to the metal powder increases thickness t3 of non-magnetic resin layer 3. Thickness t3 is adjustable by adjusting the mixing ratio of the metal powder and the resin material. The formation of non-magnetic resin layer 3 described above may be repeated to increase thickness t3 of non-magnetic resin layer 3. On the other hand, relative permittivity ε3 of non-magnetic resin layer 3 is adjustable depending on the type of the resin material of non-magnetic resin layer 3.

After non-magnetic resin layer 3 is formed on the surface of metal magnetic particle 1, inorganic insulating layer 2 coating non-magnetic resin layer 3 is formed (step S12). Specifically, for example, the powder containing metal magnetic particles 1 each formed with non-magnetic resin layer 3 generated in step S12, a metal alkoxide, such as tetraethoxysilane (TEOS), and water are caused to react in the presence of a base catalyst, such as ammonia water, in an organic solvent in which non-magnetic resin layer 3 is insoluble. Accordingly, hydrolyzed TEOS polymerizes to generate a silicon oxide layer as inorganic insulating layer 2 on non-magnetic resin layer 3. Note that the base catalyst may be replaced with an acid catalyst, such as a hydrochloric acid or an acetic acid, in the reaction. Inorganic insulating layer 2 may be formed by a thin film deposition process, for example.

Through the steps described above, the magnetic powder containing magnetic particles 5 is obtained.

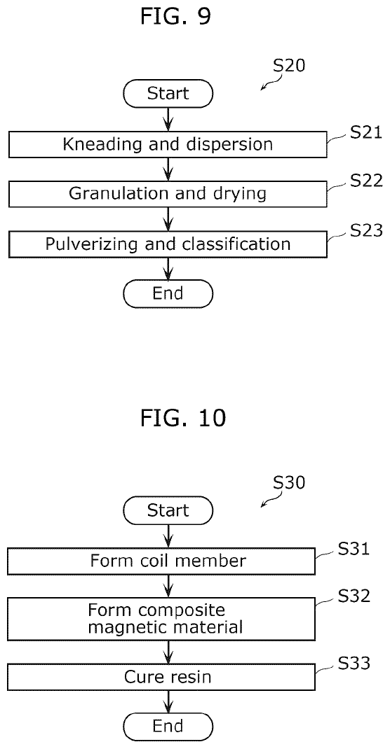

FIG. 9 is a flowchart showing the step of manufacturing the granulated powder according to this embodiment. As shown in FIG. 9, in the step of manufacturing the granulated powder, first, the magnetic powder generated in the coating step, the resin material which is the material of non-magnetic resin member 4, and the organic solvent are kneaded and dispersed (step S21). Accordingly, a mixture is generated which contains the organic solvent, the magnetic powder, and the resin material. In step S21, other materials, such as an organic metal soap and a coupling agent, may be further added, kneaded, and dispersed. Examples of the organic solvent include toluene, xylene, ethanol, and methyl ethyl ketone.

The kneading and dispersion are performed as follows. The weighted materials, such as the magnetic powder, the resin material, and the organic solvent, are put into a container, mixed with a rotary ball mill, and disperse. A higher mixing ratio of the resin material to the magnetic powder increases thickness t4 described above. Thickness t4 is adjustable by adjusting the mixing ratio of the magnetic powder and the resin material. On the other hand, relative permittivity ε4 of non-magnetic resin member 4 is adjustable depending on the type of the resin material which is the material of non-magnetic resin member 4.

The kneading and dispersion described above are performed at a room temperature, for example. The kneading and dispersion are not limited to those using a rotary ball mill but may be other ones.

After the magnetic powder, the resin material, and the organic solvent are kneaded and dispersed, granulation and drying are performed (step S22). Specifically, the mixture generated in step S21 is subjected to heat treatment at a predetermined temperature. This heat treatment removes the organic solvent from the mixture and provides the granulated powder made of the magnetic powder and the resin material.

The predetermined temperature may be set to a temperature capable of removing the organic solvent depending on the boiling point of the organic solvent, for example. If the resin material making non-magnetic resin layer 3 is a thermosetting resin, the predetermined temperature may be lower than the curing temperature of the thermosetting resin, for example. That is, the subsequent steps are performed with the resin material making non-magnetic resin layer 3 uncured. The predetermined temperature is within a range from 65° C. to 150° C., for example. In step S22, the thermosetting resin making non-magnetic resin layer 3 may be cured.

Next, the granulated powder granulated in step S22 is further crushed into powder, the pulverized granulated powder is classified into predetermined particle sizes (step S23). This provides the magnetic material made of the granulated powder.

FIG. 10 is a flowchart showing the step of manufacturing a core and assembling a coil according to this embodiment. As shown in FIG. 10, first, coil member 23 is formed (step S31). Wound part 23a of coil member 23 is obtained by winding a conductor made of metal, such as copper, a predetermined number of times. In place of step S31, coil member 23 formed in advance may be prepared.

Then, composite magnetic material 12 is molded (step S32). Composite magnetic material 12 may be made of the magnetic material manufactured in the step of manufacturing the granulated powder. First, the magnetic material classified in the step of manufacturing the granulated powder is put into a mold. At this time, coil member 23 and the magnetic material are put into the mold so that the magnetic material covers the parts of coil member 23 other than the end of wound part 23a of the conductor of coil member 23, for example.

Subsequently, uniaxial molding is performed at a molding pressure ranging from 0.1 ton/cm² to 15 ton/cm², for example, to produce a molded body. The molding pressure may range from 4.5 ton/cm² to 15 ton/cm². A higher molding pressure decreases thickness t4 described above. Thickness t4 is adjustable by the molding pressure. Thickness t4 described above is also adjustable by the amount of the resin material which is the material of non-magnetic resin member 4 to be added.

The molded body may be in the shape of composite magnetic material 12 shown in FIGS. 1 and 2, for example. Note that the shape of the molded body is not limited thereto and may be another shape. Alternatively, coil member 23 may be assembled without being put into a mold. A molded body made of a magnetic material in the shape of composite magnetic material 12 may be molded, and the molded body and coil member 23 may be assembled.

In addition, the molded body is subjected to thermal curing (step S33). The thermal curing of the molded body is performed within a temperature range from 100° C. to 300° C., for example, at a predetermined oxygen partial pressure. Accordingly, the thermosetting resin making non-magnetic resin layer 3 and non-magnetic resin member 4 is cured, for example. The thermal curing of the molded body uses an atmosphere control electric furnace. The thermal curing of the molded body may employ another method.

After the thermal curing of the molded body, the end of wound part 23a of coil member 23 may be connected to wiring 23b to be provided outside composite magnetic material 12.

Through the steps described above, coil component 10 including composite magnetic material 12 and coil member 23 is complete.

### [2. Electric Field Analysis of Composite Magnetic Material]

Next, results of electric field analysis of a composite magnetic material made of magnetic powder containing magnetic particles 5 according to the embodiment will be described.

The electric field analysis used analysis models of a composite magnetic material made of magnetic powder containing magnetic particles 5 according to the embodiment, and analysis models of a composite magnetic material made of magnetic powder containing magnetic particles 5X according to the comparative example. In addition, the electric field analysis was performed under various conditions obtained by changing the relationship between thickness t3 of non-magnetic resin layer 3 and thickness t4 of non-magnetic resin member 4, and the relationship between relative permittivity ε3 of non-magnetic resin layer 3 and relative permittivity ε4 of non-magnetic resin member 4. Based on the electric field analysis, the relationship between thickness t3 of non-magnetic resin layer 3 and thickness t4 of non-magnetic resin member 4 and the relationship between relative permittivity ε3 of non-magnetic resin layer 3 and relative permittivity ε4 of non-magnetic resin member 4 were determined which effectively increase the withstand voltage of a composite magnetic material.

### [2-1. Analysis Models]

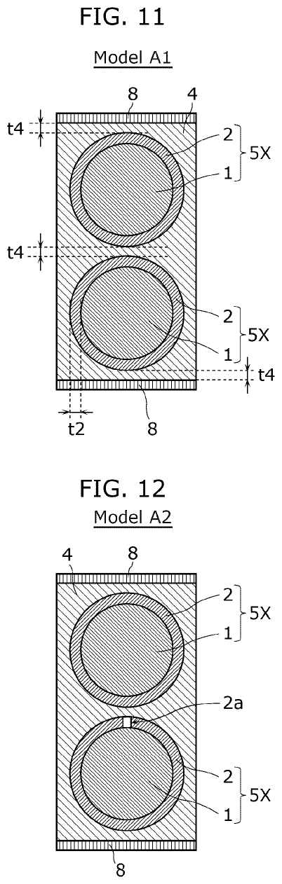

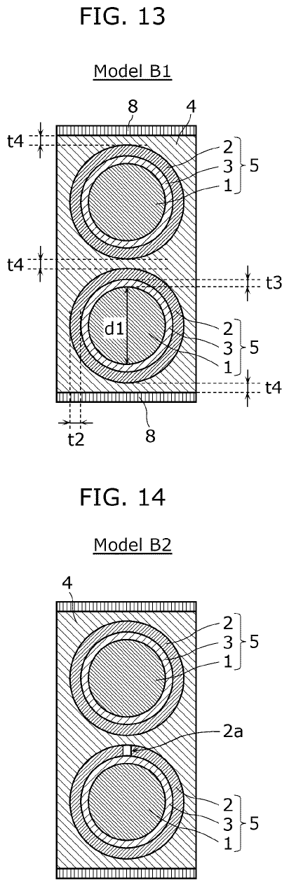

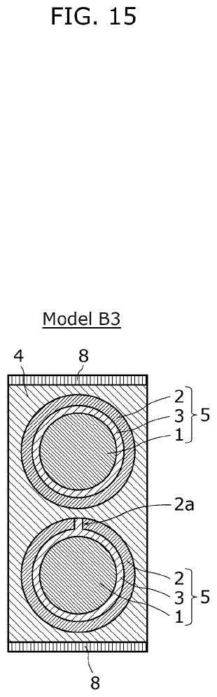

First, analysis models used for the electric field analysis will be described. FIG. 11 shows an analysis model containing magnetic particles 5X according to the comparative example. FIG. 12 shows another analysis model containing magnetic particles 5X according to the comparative example. FIG. 13 shows an analysis model containing magnetic particles 5 according to the embodiment. FIG. 14 shows another analysis model containing magnetic particles 5 according to the embodiment. FIG. 15 shows further another analysis model containing magnetic particles 5 according to the embodiment.

As shown in FIGS. 11 to 15, the electric field analysis used five two-dimensional analysis models of: model A1; model A2; model B1; model B2; and model B3. In each analysis model, two magnetic particles 5 or 5X are aligned between two electrodes 8 along the alignment of electrodes 8. In each analysis model, magnetic particles 5 or 5X are covered by non-magnetic resin member 4. In addition, in each analysis model, non-magnetic resin member 4 is disposed between electrodes 8 and magnetic particles 5 or 5X and between two magnetic particles 5 or 5X. Each magnetic particle 5X according to the comparative example includes no non-magnetic resin layer 3, and includes metal magnetic particle 1, and inorganic insulating layer 2 directly coating the surface of metal magnetic particle 1.

As shown in FIG. 11, model A1 contains magnetic particles 5X according to the comparative example. In model A1, inorganic insulating layer 2 of each magnetic particle 5X has no crack 2a.

As shown in FIG. 12, model A2 contains magnetic particles 5X according to the comparative example. In model A2, inorganic insulating layer 2 of one of magnetic particles 5X has crack 2a which is void inside.

As shown in FIG. 13, model B1 contains magnetic particles 5 according to the embodiment. In model B1, inorganic insulating layer 2 of each magnetic particle 5 has no crack 2a.

As shown in FIG. 14, model B2 contains magnetic particles 5 according to the embodiment. In model B2, inorganic insulating layer 2 of one of magnetic particles 5 has crack 2a which is void inside.

As shown in FIG. 15, model B3 contains magnetic particles 5 according to the embodiment. In model B3, inorganic insulating layer 2 of one of magnetic particles 5 has crack 2a filled with the resin material of non-magnetic resin layer 3.

### [2-2. Method of Electric Field Analysis]

In the electric field analysis, the numerical values other than thickness t3 and relative permittivity ε3 of non-magnetic resin layer 3 were fixed. The numerical values of thickness t3 and relative permittivity ε3 of non-magnetic resin layer 3 were changed to compare the electric field distributions in the analysis models. The fixed numerical values are as shown in Table 1. Note that the analysis was performed with metal magnetic particles 1 and electrodes 8 regarded as perfect conductors.

TABLE 1

| Particle Size d1 of Magnetic Powder 1 | 10 | μm |
|---|---|---|
| Thickness t2 of Inorganic Insulating Layer 2 | 10 | nm |
| Thickness t4 of Non-Magnetic Resin Member 4 | 10 | nm |
| Size of Crack 2a | 10 nm × | |
| | 10 nm | |
| Width of Electrodes 8 and Non-Magnetic Resin Members | 12 | μm |

| | |
|---|---|
| 4 (Width Orthogonal to Alignment of Electrodes 8) | |
| Relative Permittivity ε2 of Inorganic Insulating Layer 2 | 3.8 |
| Relative Permittivity ε4 of Non-Magnetic Resin Member 4 | 4 |
| Relative Dielectric Constant of Crack 2a (Void) | 1 |

The electric field analysis used Femtet (registered trademark) manufactured by Murata Software Co., Ltd. With the voltage set to apply an electric field of 20 V/mm between two electrodes 8, results of simulating the electric field distributions in the analysis modes are output.

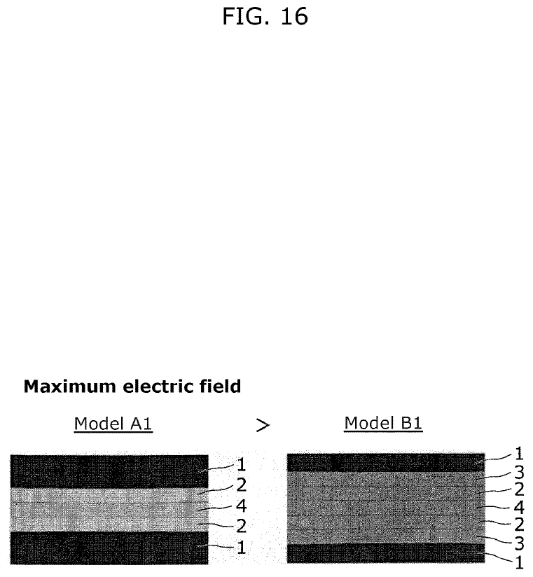

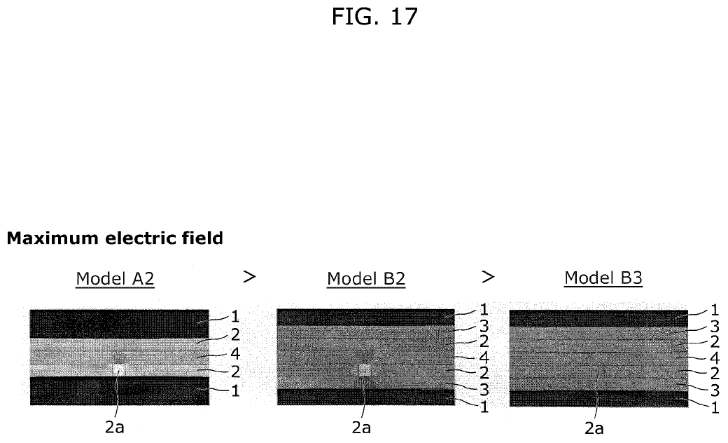

FIGS. 16 and 17 show example results of electric field analysis. FIGS. 16 and 17 show results of electric field analysis in the vicinity between two magnetic particles 5 or 5X under condition E2 (t3=t4, ε3=ε4) which will be described later. FIGS. 16 and 17 show that the points in lighter colors have a larger electric field.

As shown in FIG. 16, when model A1 and model B1 are compared, model B1 with non-magnetic resin layer 3 has a smaller electric field as a whole. That is, model B1 has a smaller maximum electric field than model A1. As shown in FIG. 17, in model A2 with crack 2a in inorganic insulating layer 2, inorganic insulating layer 2 has an electric field equivalent to that in model A1 shown in FIG. 16. The void inside crack 2a has a larger electric field than the other points. Like in model A2, in model B2 with non-magnetic resin layer 3, the void inside crack 2a has a larger electric field than the other points. The void inside crack 2a in model B2 has a smaller electric field than in model A2. In model B3 with crack 2a filled with the resin material of non-magnetic resin layer 3, the inside of crack 2a has a smaller electric field than in model B2. In this manner, the maximum electric fields of the analysis models shown in FIG. 17 are in the descending order of model A2, model B2, and model B3. With a smaller maximum electric field, dielectric breakdown is less likely to occur and the withstand voltage of a composite magnetic material increases.

In the description of the results of electric field analysis, the electric field distributions shown in FIGS. 16 and 17 are quantified as follows. In the result of analysis of the analysis models, the maximum electric field ratios of the analysis models (i.e., models B1, B2, and B3) containing magnetic particles 5 according to the embodiment are calculated with respect to the analysis models (i.e., models A1 and A2) containing magnetic particles 5X according to the comparative example. With a maximum electric field ratio smaller than one, the analysis models according to the embodiment have a smaller maximum electric field ratio than the analysis models according to the comparative example. It can be said that the withstand voltage of a composite magnetic material increases.

Specifically, the following four pairs of analysis models are selected to calculate the maximum electric field ratio:
(1) model A1 and model B1 (B1/A1);
(2) model A2 and model B1 (B1/A2);
(3) model A2 and model B2 (B2/A2); and
(4) model A2 and model B3 (B3/A2).
   In the pair (1), magnetic particles 5X and magnetic particles 5 each without crack 2a are compared. In the pairs of (2) to (4), magnetic particle 5X with crack 2a is compared to magnetic particle 5 without crack 2a, magnetic particle 5 with void crack 2a, and magnetic particle 5 with crack 2a filled with the resin material of non-magnetic resin layer 3, respectively.

The maximum electric field ratio was calculated at the three points of comparison of: non-magnetic resin member 4; inorganic insulating layer 2; and the whole component. For example, if the point of comparison is non-magnetic resin member 4 or inorganic insulating layer 2, the maximum electric field ratio was calculated based on the maximum electric field only in non-magnetic resin member 4 or inorganic insulating layer 2. If the point of comparison is the whole component, the maximum electric field ratio was calculated based on the maximum electric field of the entire analysis model.

Whether the withstand voltage of a composite magnetic material increases in the use of magnetic particles 5 according to the embodiment is evaluated based on the following indices.

Excellent: maximum electric field ratio is less than one in all points of comparison of: non-magnetic resin member 4; inorganic insulating layer 2; and the whole component

Good: maximum electric field ratio is less than one in comparison of the whole component

Poor: maximum electric field ratio is one or more in comparison of the whole component

### [2-3. Results of Electric Field Analysis]

First, Table 2 shows results of electric field analysis performed by changing thickness t3 and relative permittivity (RP) 23 of non-magnetic resin layer 3 from condition C1 to condition F3.

TABLE 2

| | | | | Maximum Electric Field Ratio | | | | |
|---|---|---|---|---|---|---|---|---|
| Condition | Thickness | RP | Point of Comparison | B1/A1 | B1/A2 | B2/A2 | B3/A2 | Evaluation |
| C1 | t3 = 0.75 × t4 | ε3 < ε4 | Non-Magnetic Resin Member 4 | 0.526 | 0.463 | 0.560 | 0.486 | Poor |
| | (t3 = 7.5 nm) | (ε3 = 2) | Inorganic Insulating Layer 2 | 0.526 | 0.369 | 0.597 | 0.467 | |
| | | | Whole Component | 1.001 | 0.555 | 0.633 | 0.569 | |
| C2 | | ε3 = ε4 | Non-Magnetic Resin Member 4 | 0.690 | 0.607 | 0.717 | 0.620 | Excellent |
| | | (ε3 = 4) | Inorganic Insulating Layer 2 | 0.690 | 0.484 | 0.739 | 0.483 | |
| | | | Whole Component | 0.690 | 0.383 | 0.742 | 0.382 | |
| C3 | | ε3 > ε4 | Non-Magnetic Resin Member 4 | 0.817 | 0.718 | 0.835 | 0.927 | Excellent |
| | | (ε3 = 8) | Inorganic Insulating Layer 2 | 0.817 | 0.573 | 0.828 | 0.567 | |
| | | | Whole Component | 0.817 | 0.453 | 0.851 | 0.555 | |
| D1 | t3 = 0.76 × t4 | ε3 < ε4 | Non-Magnetic Resin Member 4 | 0.523 | 0.460 | 0.558 | 0.484 | Excellent |
| | (t3 = 7.6 nm) | (ε3 = 2) | Inorganic Insulating Layer 2 | 0.523 | 0.367 | 0.586 | 0.443 | |
| | | | Whole Component | 0.995 | 0.552 | 0.664 | 0.565 | |
| D2 | | ε3 = ε4 | Non-Magnetic Resin Member 4 | 0.687 | 0.604 | 0.716 | 0.617 | Excellent |
| | | (ε3 = 4) | Inorganic Insulating Layer 2 | 0.687 | 0.482 | 0.740 | 0.480 | |
| | | | Whole Component | 0.687 | 0.381 | 0.738 | 0.380 | |
| D3 | | ε3 > ε4 | Non-Magnetic Resin Member 4 | 0.815 | 0.717 | 0.835 | 0.925 | Excellent |
| | | (ε3 = 8) | Inorganic Insulating Layer 2 | 0.815 | 0.571 | 0.862 | 0.565 | |
| | | | Whole Component | 0.815 | 0.452 | 0.848 | 0.553 | |
| E1 | t3 = t4 | ε3 < ε4 | Non-Magnetic Resin Member 4 | 0.455 | 0.400 | 0.422 | 0.422 | Excellent |
| | (t3 = 10 nm) | (ε3 = 2) | Inorganic Insulating Layer 2 | 0.455 | 0.319 | 0.408 | 0.408 | |
| | | | Whole Component | 0.865 | 0.480 | 0.493 | 0.426 | |
| E2 | | ε3 = ε4 | Non-Magnetic Resin Member 4 | 0.625 | 0.550 | 0.658 | 0.562 | Excellent |
| | | (ε3 = 4) | Inorganic Insulating Layer 2 | 0.625 | 0.438 | 0.681 | 0.437 | |
| | | | Whole Component | 0.625 | 0.347 | 0.679 | 0.346 | |
| E3 | | ε3 > ε4 | Non-Magnetic Resin Member 4 | 0.770 | 0.677 | 0.794 | 0.870 | Excellent |
| | | (ε3 = 8) | Inorganic Insulating Layer 2 | 0.770 | 0.540 | 0.788 | 0.534 | |
| | | | Whole Component | 0.770 | 0.427 | 0.808 | 0.422 | |
| F1 | t3 = 2 × t4 | ε3 < ε4 | Non-Magnetic Resin Member 4 | 0.295 | 0.259 | 0.329 | 0.275 | Excellent |
| | (t3 = 20 nm) | (ε3 = 2) | Inorganic Insulating Layer 2 | 0.294 | 0.206 | 0.340 | 0.268 | |
| | | | Whole Component | 0.561 | 0.311 | 0.395 | 0.322 | |
| F2 | | ε3 = ε4 | Non-Magnetic Resin Member 4 | 0.456 | 0.401 | 0.495 | 0.409 | Excellent |
| | | (ε3 = 4) | Inorganic Insulating Layer 2 | 0.455 | 0.319 | 0.511 | 0.319 | |
| | | | Whole Component | 0.455 | 0.253 | 0.512 | 0.252 | |
| F3 | | ε3 > ε4 | Non-Magnetic Resin Member 4 | 0.627 | 0.551 | 0.663 | 0.700 | Excellent |
| | | (ε3 = 8) | Inorganic Insulating Layer 2 | 0.626 | 0.439 | 0.683 | 0.435 | |
| | | | Whole Component | 0.626 | 0.347 | 0.675 | 0.419 | |

As shown in Table 2, the withstand voltage is evaluated as being “Excellent”, where t3 is 7.6 nm or more, that is, t3≥0.76×t4 in the item “Thickness”. It is found that the withstand voltage of the composite magnetic material increases which contains magnetic particles 5 according to the embodiment.

Next, Table 3 shows results of electric field analysis performed by changing thickness t3 and relative Permittivity (RP) ε3 of non-magnetic resin layer 3 from condition E1 to condition H3. In Table 3, the results of conditions E1 to F3 are the same as in Table 2.

TABLE 3

| | | | | Maximum Electric Field Ratio | | | | |
|---|---|---|---|---|---|---|---|---|
| Condition | Thickness | RP | Point of Comparison | B1/A1 | B1/A2 | B2/A2 | B3/A2 | Evaluation |
| G1 | t3 = 0.44 × t4 | ε3 < ε4 | Non-Magnetic Resin Member 4 | 0.654 | 0.575 | 0.772 | 0.619 | Poor |
| | (t3 = 4.4 nm) | (ε3 = 2) | Inorganic Insulating Layer 2 | 0.654 | 0.459 | 0.747 | 0.558 | |
| | | | Whole Component | 1.245 | 0.690 | 0.881 | 0.725 | |
| G2 | | ε3 = ε4 | Non-Magnetic Resin Member 4 | 0.791 | 0.695 | 0.858 | 0.707 | Excellent |
| | | (ε3 = 4) | Inorganic Insulating Layer 2 | 0.791 | 0.554 | 0.847 | 0.552 | |
| | | | Whole Component | 0.791 | 0.439 | 0.827 | 0.437 | |
| G3 | | ε3 > ε4 | Non-Magnetic Resin Member 4 | 0.883 | 0.776 | 0.949 | 1.001 | Good |
| | | (ε3 = 8) | Inorganic Insulating Layer 2 | 0.883 | 0.619 | 0.933 | 0.611 | |
| | | | Whole Component | 0.883 | 0.490 | 0.904 | 0.599 | |
| H1 | t3 = 0.45 × t4 | ε3 < ε4 | Non-Magnetic Resin Member 4 | 0.649 | 0.571 | 0.717 | 0.615 | Poor |
| | (t3 = 4.5 nm) | (ε3 = 2) | Inorganic Insulating Layer 2 | 0.649 | 0.455 | 0.743 | 0.554 | |
| | | | Whole Component | 1.235 | 0.685 | 0.872 | 0.719 | |
| H2 | | ε3 = ε4 | Non-Magnetic Resin Member 4 | 0.787 | 0.692 | 0.855 | 0.704 | Excellent |
| | | (ε3 = 4) | Inorganic Insulating Layer 2 | 0.787 | 0.552 | 0.844 | 0.550 | |
| | | | Whole Component | 0.787 | 0.437 | 0.824 | 0.435 | |
| H3 | | ε3 > ε4 | Non-Magnetic Resin Member 4 | 0.883 | 0.774 | 0.947 | 0.997 | Excellent |
| | | (ε3 = 8) | Inorganic Insulating Layer 2 | 0.883 | 0.617 | 0.931 | 0.610 | |
| | | | Whole Component | 0.883 | 0.488 | 0.902 | 0.597 | |
| E1 | t3 = t4 | ε3 < ε4 | Non-Magnetic Resin Member 4 | 0.455 | 0.400 | 0.422 | 0.422 | Excellent |
| | (t3 = 10 nm) | (ε3 = 2) | Inorganic Insulating Layer 2 | 0.455 | 0.319 | 0.408 | 0.408 | |
| | | | Whole Component | 0.865 | 0.480 | 0.493 | 0.426 | |
| E2 | | ε3 = ε4 | Non-Magnetic Resin Member 4 | 0.625 | 0.550 | 0.658 | 0.562 | Excellent |
| | | (ε3 = 4) | Inorganic Insulating Layer 2 | 0.625 | 0.438 | 0.681 | 0.437 | |
| | | | Whole Component | 0.625 | 0.347 | 0.679 | 0.346 | |
| E3 | | ε3 > ε4 | Non-Magnetic Resin Member 4 | 0.770 | 0.677 | 0.794 | 0.870 | Excellent |
| | | (ε3 = 8) | Inorganic Insulating Layer 2 | 0.770 | 0.540 | 0.788 | 0.534 | |
| | | | Whole Component | 0.770 | 0.427 | 0.808 | 0.422 | |
| F1 | t3 = 2 × t4 | ε3 < ε4 | Non-Magnetic Resin Member 4 | 0.295 | 0.259 | 0.329 | 0.275 | Excellent |
| | (t3 = 20 nm) | (ε3 = 2) | Inorganic Insulating Layer 2 | 0.294 | 0.206 | 0.340 | 0.268 | |
| | | | Whole Component | 0.561 | 0.311 | 0.395 | 0.322 | |
| F2 | | ε3 = ε4 | Non-Magnetic Resin Member 4 | 0.456 | 0.401 | 0.495 | 0.409 | Excellent |
| | | (ε3 = 4) | Inorganic Insulating Layer 2 | 0.455 | 0.319 | 0.511 | 0.319 | |
| | | | Whole Component | 0.455 | 0.253 | 0.512 | 0.252 | |
| F3 | | ε3 > ε4 | Non-Magnetic Resin Member 4 | 0.627 | 0.551 | 0.663 | 0.700 | Excellent |
| | | (ε3 = 8) | Inorganic Insulating Layer 2 | 0.626 | 0.439 | 0.683 | 0.435 | |
| | | | Whole Component | 0.626 | 0.347 | 0.675 | 0.419 | |

As shown in Table 3, the withstand voltage is evaluated as being “Good” or “Excellent”, where ε3 is 4 or more, that is, ε3≥ε4 in the item “Relative Permittivity”. It is found that the withstand voltage of the composite magnetic material increases which contains magnetic particles 5 according to the embodiment. Further, the withstand voltage is evaluated as being “Excellent”, where ε3≥ε4 and t3 is 4.5 nm or more, that is, t3≥0.45×t4. It is found that the withstand voltage of the composite magnetic material further increases which contains magnetic particles 5 according to the embodiment.

The foregoing results show that the withstand voltage of a composite magnetic material can increase when satisfying any of:

$$t 3 \geq 0.76 \times t 4 ; \qquad ( i )$$

$$t 3 \geq 0.45 \times t 4 and ε 3 \geq ε 4 ; or \qquad ( ii )$$

$$ε 3 \geq ε 4. \qquad ( iii )$$

In particular, the withstand voltage of a composite magnetic material can further increase when satisfying (i) t3≥0.76×t4 or (ii) t3≥0.45×t4 and ε3≥ε4.

The results of analysis described above are examples and are not intended to limit the scope of the present disclosure. For example, in the results of electric field analysis, even if an analysis model has a maximum electric field ratio of one or more, actually existing non-magnetic resin layer 3 reduces the contact between metal magnetic particles 1. With the use of magnetic particles 5, the withstand voltage of a composite magnetic material increases more than in the use of magnetic particles 5X according to the comparative example.

### OTHER EMBODIMENTS

While the magnetic powder, the composite magnetic material, etc. according to the embodiment of the present disclosure have been described above, the present disclosure is not limited to this embodiment.

For example, the present disclosure includes electrical components made of the composite magnetic material described above. Examples of the electrical components include inductance components, such as a high-frequency reactor, an inductor, and a transformer. The present disclosure also includes power supply devices including the electrical components described above.

The present disclosure is not limited to the embodiment described above. The one or more aspects may include forms obtained by various modifications to the foregoing embodiment that can be conceived by those skilled in the art or forms achieved by freely combining the elements and functions in the foregoing embodiment without departing from the scope and spirit of the present disclosure.

### REFERENCE SIGNS LIST

1 metal magnetic particles
2 inorganic insulating layer
2a crack
3 non-magnetic resin layer
4 non-magnetic resin member
5 magnetic particles
8 electrode
10 coil component
12 composite magnetic material
12a core
23 coil member
23a wound part
23b wiring

1. Magnetic powder comprising:
magnetic particles, wherein
each of the magnetic particles includes:
a metal magnetic particle;
a non-magnetic resin layer coating a surface of the metal magnetic particle; and
an inorganic insulating layer coating the non-magnetic resin layer.

2. A composite magnetic material comprising:
the magnetic powder according to claim 1; and
a non-magnetic resin member that binds the magnetic particles of the magnetic powder.

3. The composite magnetic material according to claim 2, wherein
t3≥0.76×t4 is satisfied, where
t3 is a thickness of the non-magnetic resin layer, and
t4 is a thickness of a thinnest part of the non-magnetic resin member between adjacent ones of the magnetic particles of the magnetic powder.

4. The composite magnetic material according to claim 2, wherein
t3≥0.45×t4 and ε3≥ε4 are satisfied, where
t3 is a thickness of the non-magnetic resin layer,
t4 is a thickness of a thinnest part of the non-magnetic resin member between an adjacent pair of the magnetic particles of the magnetic powder,
ε3 is a relative permittivity of the non-magnetic resin layer, and
ε4 is a relative dielectric constant of the non-magnetic resin member.

5. The composite magnetic material according to claim 2, wherein
ε3≥ε4 is satisfied, where
ε3 is a relative permittivity of the non-magnetic resin layer, and
ε4 is a relative permittivity of the non-magnetic resin member.

6. The composite magnetic material of claim 2, wherein
the inorganic insulating layer includes a crack, and
at least a part of the crack is filled with a resin material of the non-magnetic resin layer.
